(19) United States
(12) Patent Application Publication
(10) Pub. No.: US 2026/0204839 A1
(43) Pub. Date: Jul. 16, 2026

(54) CONNECTOR

(71) Applicant: SUMITOMO WIRING SYSTEMS, LTD., Mie (JP)

(72) Inventor: Hidekazu MATSUDA, Mie (JP)

(21) Appl. No.: 19/138,667

(22) PCT Filed: Nov. 28, 2023
(86) PCT No.: PCT/JP2023/042448

§ 371 Date: Jun. 13, 2025

(30) Foreign Application Priority Data
Dec. 19, 2022 (JP) 2022-202484

(51) Int. Cl. H01R 13/627; H01R 12/71; H01R 13/516; H01R 13/641

(52) U.S. Cl. CPC H01R 13/6272; H01R 12/716; H01R 13/516; H01R 13/641

(57) ABSTRACT

A tubular fitting portion of a first housing includes: an upper wall that covers a second housing; a pair of ribs that protrude inward from the upper wall and face each other in the left-right direction; and a lock portion that protrudes inward from the upper wall and is positioned between the ribs. The second housing includes a lock arm that is positioned between the ribs. The lock arm includes an arm body, and a lock protrusion configured to engage with the lock portion. The dimension of the lock protrusion in the left-right direction is smaller than the dimension of the arm body in the left-right direction. The first housing includes reinforcement portions located at positions that are outside the lock protrusion in the left-right direction and overlap with the arm body in the left-right direction. The reinforcement portions protrude from the upper wall to the respective ribs.

### TECHNICAL FIELD

The present disclosure relates to a connector.

### BACKGROUND

The connector disclosed in Patent Document 1 includes a male housing and a female housing that can be fitted to each other. The male housing and the female housing are held in a fitted state by the engagement of an engagement protrusion of the male housing and an engagement portion of the female housing. As this type of connector, the configuration disclosed in Patent Document 2 is also known.

### PRIOR ART DOCUMENT

### Patent Document

Patent Document 1: JP H07-220807 A

Patent Document 2: JP 2020-170599 A

### SUMMARY OF THE INVENTION

### Problems to be Solved

When a force is applied in the direction of separating the fitted housings while the engagement protrusion and the engagement portion are engaged with each other, the lock protrusion and the engagement protrusion are pressed against each other. With this, an engagement chamber in which the engagement portion is provided may bend outward, and the engagement between the engagement protrusion and the engagement portion may be disengaged.

The connector of the present disclosure has been accomplished in view of the above-mentioned circumstances, and aims to increase a force to maintain the fitted state.

### Means to Solve the Problem

According to the present disclosure, a connector includes: a first housing and a second housing; wherein the first housing includes a tubular fitting portion to which the second housing can be fitted, the tubular fitting portion includes: a covering wall that externally covers the second housing; a pair of ribs that protrude inward from the covering wall and face each other in a width direction that intersects with a fitting direction of the first housing and second housing; and a lock portion that protrudes inward from the covering wall and is positioned between the ribs, the second housing includes a lock arm that is positioned between the ribs when the second housing is fitted to the first housing, the lock arm includes an arm body that is elastically deformable, and a lock protrusion that protrudes from the arm body and is configured to engage with the lock portion, a dimension of the lock protrusion in the width direction is smaller than a dimension of the arm body in the width direction, the first housing includes reinforcement portions located at positions that are outside the lock protrusion in the width direction and overlap with the arm body in the width direction when the first housing is fitted to the second housing, and the reinforcement portions protrude from the covering wall to the ribs.

### Effect of the Invention

According to the present disclosure, it is possible to increase a force to maintain the fitted state of a connector.

### BRIEF DESCRIPTION OF THE DRAWINGS

FIG. 1 is a side cross-sectional view of a connector according to Embodiment 1.

FIG. 2 is a perspective view of a tubular fitting portion of a first housing when viewed from the front.

FIG. 3 is an enlarged back view of the main portion of the first housing when viewed from the rear.

FIG. 4 is a cross-sectional view taken along a line A-A in FIG. 3.

FIG. 5 is a partially enlarged perspective view showing a lock arm of a second housing.

FIG. 6 is a partially enlarged side cross-sectional view showing a state in which a lock portion and the lock arm are engaged with each other.

FIG. 7 is a cross-sectional view taken along a line B-B in FIG. 1.

### DETAILED DESCRIPTION TO EXECUTE THE INVENTION

### Description of Embodiments of Present Disclosure

First, embodiments of the present disclosure will be listed and described.
(1) The connector according to the present disclosure includes: a first housing and a second housing. The first housing includes a tubular fitting portion to which the second housing can be fitted. The tubular fitting portion includes: a covering wall that externally covers the second housing; a pair of ribs that protrude inward from the covering wall and face each other in a width direction that intersects with a fitting direction of the first housing and second housing; and a lock portion that protrudes inward from the covering wall and is positioned between the ribs. The second housing includes a lock arm that is positioned between the ribs when the second housing is fitted to the first housing. The lock arm includes an arm body that is elastically deformable, and a lock protrusion that protrudes from the arm body and is configured to engage with the lock portion. A dimension of the lock protrusion in the width direction is smaller than a dimension of the arm body in the width direction. The first housing includes reinforcement portions located at positions that are outside the lock protrusion in the width direction and overlap with the arm body in the width direction when the first housing is fitted to the second housing. The reinforcement portions protrude from the covering wall to the ribs. According to this configuration, the covering wall is reinforced by being connected to the ribs by the reinforcement portions, and thus it is possible to make the covering wall difficult to bend even when a force is applied in the direction of separating the first housing and the second housing from each other with the lock protrusion and the lock portion engaged with each other. This prevents the lock protrusion and the lock portion from deforming and can make it difficult for the engaged lock protrusion and lock portion to be disengaged.
(2) Preferably, the reinforcement portions extend in the fitting direction, and front ends of the reinforcement portions in the fitting direction are continuous with the lock portion. As a result of the front ends of the reinforcement portions being continuous with the lock portion, it is possible to make the covering wall more difficult to bend.
(3) In the item (2), preferably, rear ends of the reinforcement portions in the fitting direction are located forward relative to a rear end of the covering wall. Since the length dimension of the reinforcement portions in the fitting direction, the covering wall, can be defined as the minimum necessary dimension, formability can be improved.
(4) In the item (2) or (3), preferably, a top surface is formed at a leading end of the lock protrusion in a protruding direction, the top surface extending in the fitting direction while intersecting with a lock surface that faces the lock portion. Preferably, when the first housing and the second housing are in a fitted state, the top surface is located at a position included within a formation range of the reinforcement portions in the fitting direction. According to this configuration, since the reinforcement portions are provided, on the covering wall, corresponding to a range to be pressed by the lock protrusion, it is possible to effectively prevent the covering wall from bending. Here, the formation range of the reinforcement portions in the fitting direction refers to a range in the fitting direction where the reinforcement portions are arranged.

### Detail of Embodiments of Present Disclosure

### Embodiment 1

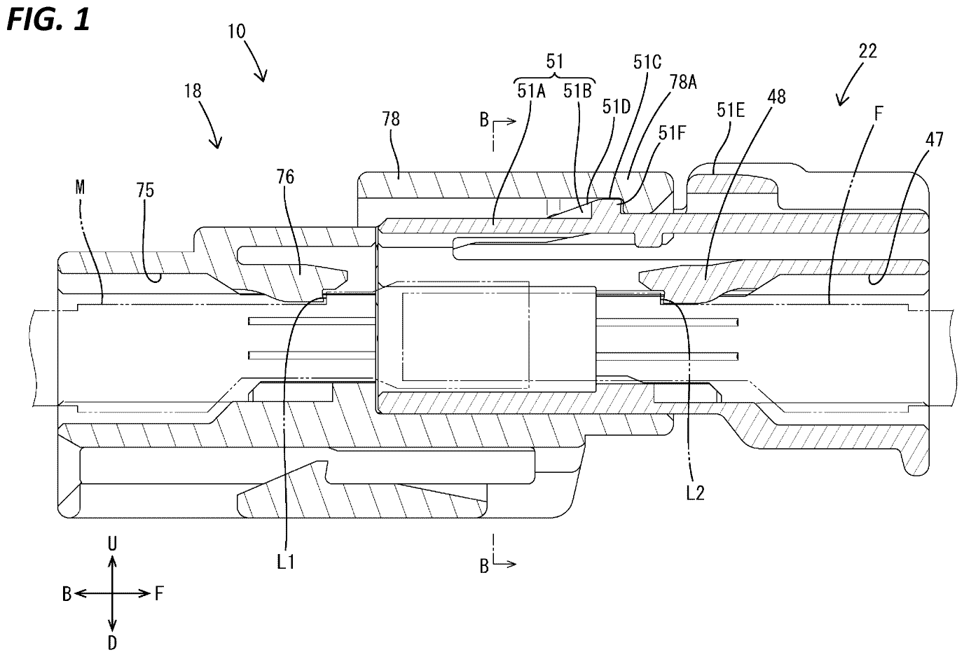

The following will describe Embodiment 1 in which a connector 10 of the present disclosure is embodied with reference to FIGS. 1 to 7. In the drawings, “front side,” “rear side,” “upper side,” “lower side,” “right side,” and “left side” are represented by “F,” “B,” “U,” “D,” “R,” and “L,” respectively. In Embodiment 1, the left-right direction corresponds to a width direction. The front side “F” in the drawings is the side of a first housing 18 that faces a second housing 22. Note that, in the description of the second housing 22, the front side is described as being the side opposite to the first housing 18. As shown in FIG. 1, the connector 10 of Embodiment 1 includes the first housing 18 and the second housing 22, which are housings that can be fitted to each other. The first housing 18 and the second housing 22 can be fitted to each other in the front-rear direction. In other words, the front-rear direction corresponds to the fitting direction.

### First Housing

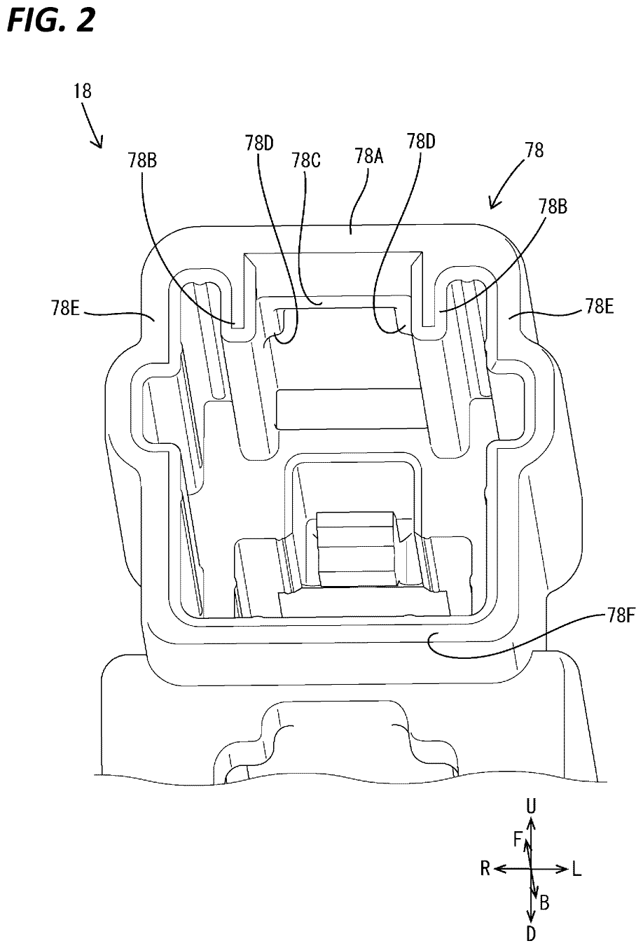

The first housing 18 is made of a synthetic resin and includes a first terminal receptacle 75 passing through the first housing 18 in the front-rear direction, as shown in FIG. 1. An elastically deformable first lance 76 is formed on the upper surface of the rear inner wall of the first terminal receptacle 75 while projecting forward in a cantilever shape. The first terminal receptacle 75 receives a male terminal M. When the male terminal M is received in the first terminal receptacle 75, the first lance 76 is engaged with an engaged portion L1 formed in the male terminal M. The front portion of the first housing 18 is formed as a tubular fitting portion 78 having a larger outer shape than the rear portion. The tubular fitting portion 78 includes an upper wall 78A, which constitutes a covering wall, left and right side walls 78E, which constitute the covering wall, and a lower wall 78F, which constitute the covering wall. The tubular fitting portion 78 is formed into a square tubular shape by the upper wall 78A, the left and right side walls 78E, and the lower wall 78F (see FIG. 2).

As shown in FIG. 2, a pair of ribs 78B protrude inward from the upper wall 78A of the tubular fitting portion 78. These ribs 78B hang down from the lower surface of the upper wall 78A and extend in the front-rear direction. These ribs 78B are spaced apart from each other in the left-right direction. In other words, these ribs 78B face each other in the left-right direction (width direction) that intersects with the fitting direction of the first housing 18 and the second housing 22.

A lock portion 78C is disposed between the pair of ribs 78B. The lock portion 78C protrudes downward (inward) from the lower surface of the upper wall 78A. Both ends of the lock portion 78C in the left-right direction are connected to the respective ribs 78B.

A pair of reinforcement portions 78D are provided on the upper wall 78A of the tubular fitting portion 78. Each of these reinforcement portions 78D is provided on one of the facing surfaces of the pair of ribs 78B. In other words, the reinforcement portions 78D protrude from the upper wall 78A to the respective ribs 78B so as to connect the upper wall 78A and the respective ribs 78B. Specifically, the reinforcement portions 78D are formed while extending in the front-rear direction (fitting direction) and protruding inward in the left-right direction along the portion in which the ribs 78B and the upper wall 78A are connected to each other. The front ends of the reinforcement portions 78D in the front-rear direction (fitting direction) are continuous with the lock portion 78C.

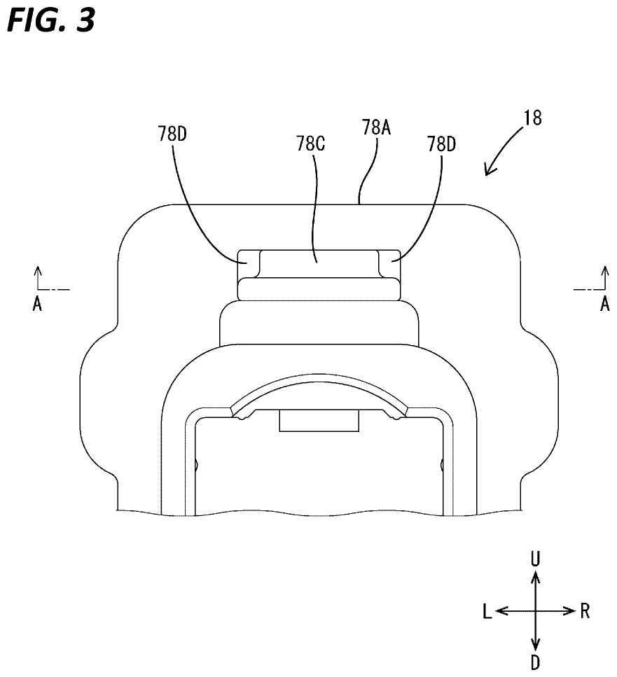

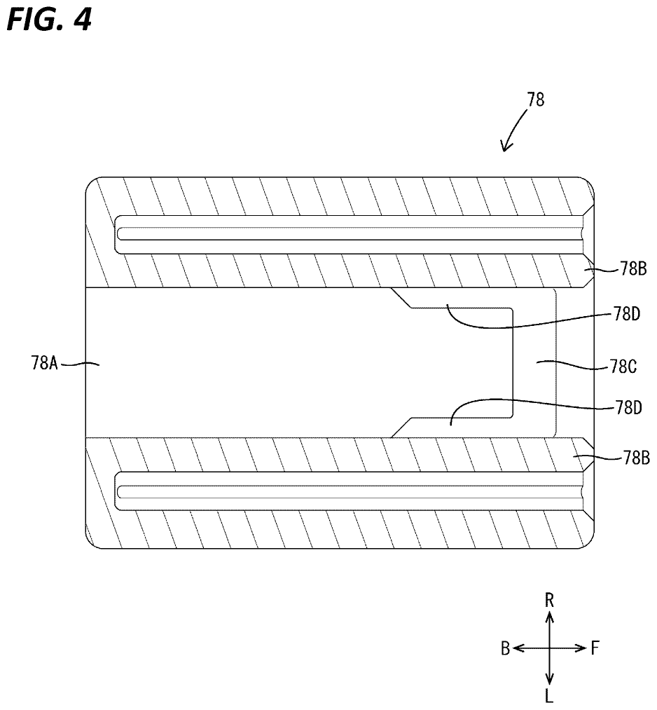

As shown in FIG. 3, when the first housing 18 is viewed from the rear, each reinforcement portion 78D has a rectangular shape. The lower surface of each reinforcement portion 78D is flush with the lower surface of the lock portion 78C. As shown in FIG. 4, the rear end of each reinforcement portion 78D is inclined outward in the left-right direction toward the corresponding rib 78B. The rear ends of the reinforcement portions 78D in the front-rear direction (fitting direction) are located forward relative to the rear end of the tubular fitting portion 78. The second housing 22 is fitted into the tubular fitting portion 78.

### Second Housing

The second housing 22 is made of a synthetic resin and includes a second terminal receptacle 47 passing through the second housing 22 in the front-rear direction, as shown in FIG. 1. A second lance 48 is formed on the upper surface of the rear inner wall of the second terminal receptacle 47 while projecting forward in a cantilever shape. The second lance 48 is elastically deformable in the up-down direction.

The second terminal receptacle 47 receives a female terminal F. When the female terminal F is received in the second terminal receptacle 47, the second lance 48 is engaged with an engaged portion L2 formed in the female terminal F. A lock arm 51 capable of engaging the first housing 18 is formed on the upper wall of the second housing 22. The lock arm 51 includes an arm body 51A that extends in the front-rear direction, and a lock protrusion 51B that protrudes from a central portion of the upper surface of the arm body 51A in the width direction.

The arm body 51A has a width in the left-right direction, is flat, and extends in the front-rear direction. A top surface 51C extending in the front-rear direction (fitting direction) is formed at the leading end (upper end) of the lock protrusion 51B in a protruding direction. An inclined surface 51D inclined forward and downward is continuous with the front end of the top surface 51C. A lock surface 51F hangs down and is continuous with the rear end of the top surface 51C. The top surface 51C intersects with the lock surface 51F. Behind the lock protrusion 51B, a finger-pressing portion 51E is provided at a rearward distance with respect to the lock protrusion 51B. The finger-pressing portion 51E protrudes upward from the arm body 51A.

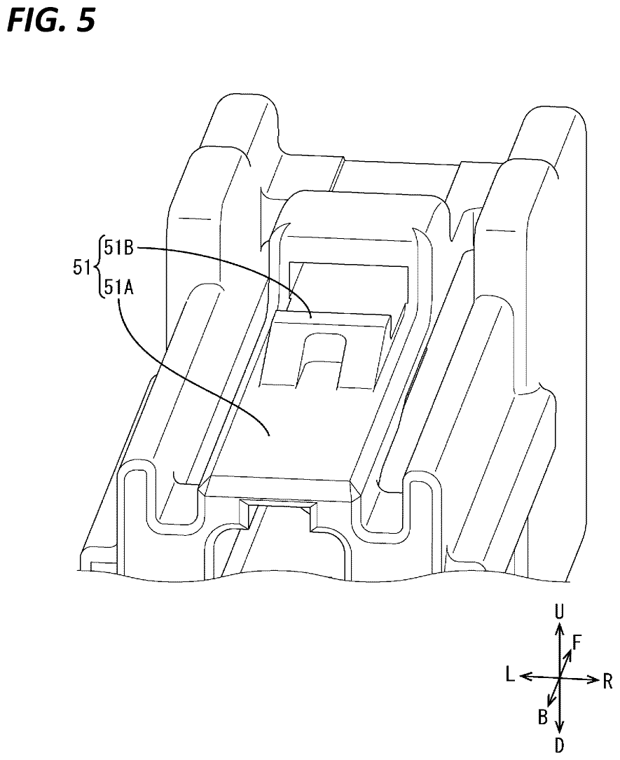

As shown in FIG. 5, the dimension (i.e., width dimension) of the lock protrusion 51B in the width direction (left-right direction) is smaller than the dimension of the arm body 51A in the width direction (left-right direction). In other words, the end surfaces of the lock protrusion 51B in the left-right direction are located at positions closer to the center of the arm body 51A in the left-right direction than the end surfaces of the arm body 51A in the left-right direction.

### Assembly Procedure and Fitting Structure of Connector

The male terminal M is inserted into the first terminal receptacle 75 of the first housing 18 from the rear. The male terminal M is retained in the first terminal receptacle 75 of the first housing 18 by causing the engaged portion LI to be engaged with the first lance 76 (see FIG. 1).

The female terminal F is inserted into the second terminal receptacle 47 of the second housing 22 from the rear. The female terminal F is retained in the second terminal receptacle 47 of the second housing 22 by causing the engaged portion L2 to be engaged with the second lance 48 (see FIG. 1).

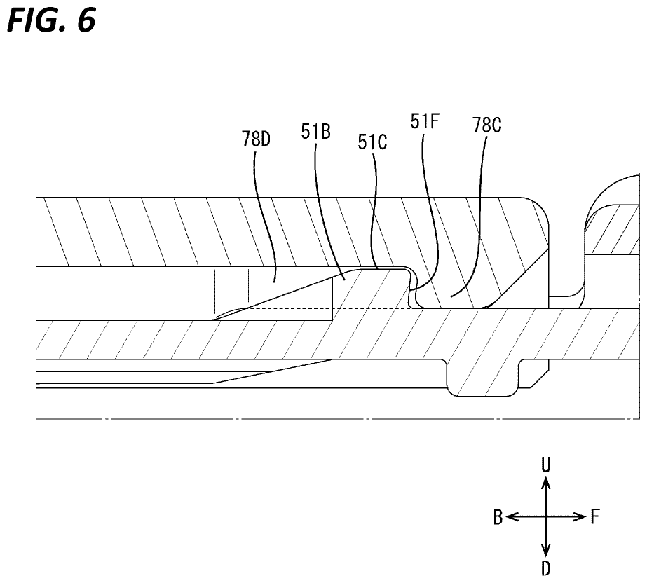

The first housing 18 and the second housing 22 are fitted to each other from a state where they face each other. Specifically, the front end of the second housing 22 is fitted into the tubular fitting portion 78 of the first housing 18. As the fitting proceeds, the lock protrusion 51B of the second housing 22 comes into contact with the lock portion 78C of the first housing 18, and the arm body 51A elastically deforms downward. When the lock protrusion 51B has passed through the lock portion 78C, the arm body 51A elastically returns and the lock surface 51F faces the lock portion 78C in the front-rear direction. The lock protrusion 51B is engaged with the lock portion 78C in the fitting direction (see FIG. 6). With this, the first housing 18 and the second housing 22 are held in a fitted state where they are fitted to each other. In the fitted state, the female terminal F and the male terminal M are fitted to each other. At this time, the tubular fitting portion 78 externally covers the second housing 22.

As shown in FIG. 6, the dimension of the reinforcement portions 78D in the front-rear direction (fitting direction) is larger than the dimension of the top surface 51C of the lock protrusion 51B. In other words, the top surface 51C is included within a range in the front-rear direction (fitting direction) where the reinforcement portions 78D are formed. The dimension of the lock protrusion 51B and the dimension of the reinforcement portions 78D in the front-rear direction (fitting direction) are approximately the same.

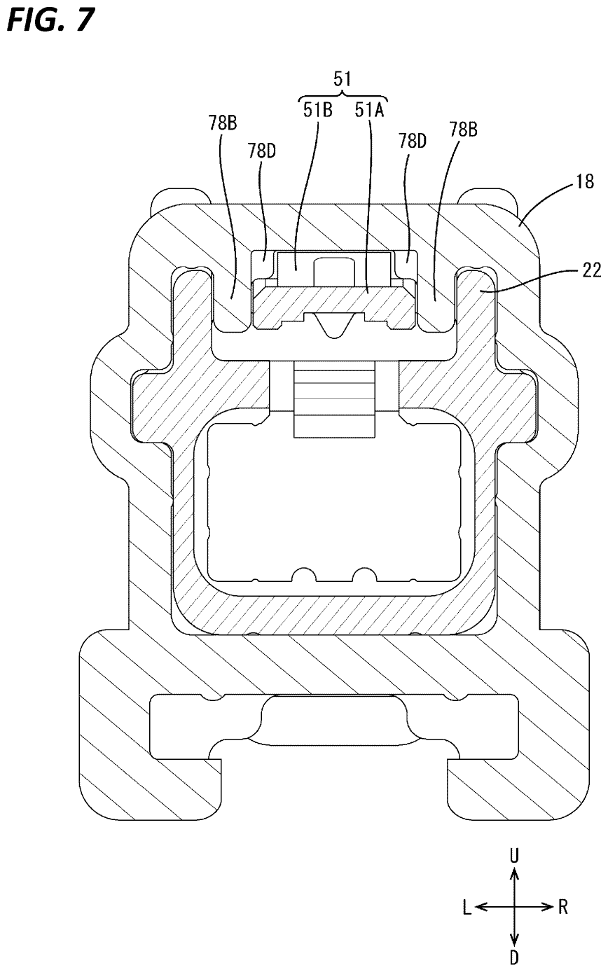

As shown in FIG. 7, when the first housing 18 and the second housing 22 are in the fitted state, the lock arm 51 is positioned between the pair of ribs 78B. When the first housing 18 and the second housing 22 are in the fitted state, the reinforcement portions 78D are located at positions that are outside the lock protrusion 51B in the width direction (left-right direction) and overlap with (i.e., lap over) the arm body 51A in the width direction (left-right direction).

Next, examples of effects of the present configurations will be described.

The connector 10 includes the first housing 18 and the second housing 22. The first housing 18 includes the tubular fitting portion 78 to which the second housing 22 can be fitted. The tubular fitting portion 78 has the upper wall 78A that externally covers the second housing 22, the pair of ribs 78B that protrude inward from the upper wall 78A and face each other in the left-right direction that intersects with the fitting direction of the first housing 18 and second housing 22, and the lock portion 78C that protrudes inward from the upper wall 78A and is positioned between the ribs 78B. The second housing 22 includes the lock arm 51 that is positioned between the ribs 78B when the second housing 22 is fitted to the first housing 18. The lock arm 51 includes the arm body 51A that is elastically deformable, and the lock protrusion 51B that protrudes from the arm body 51A and engages with the lock portion 78C. The dimension (i.e., width dimension) of the lock protrusion 51B in the left-right direction is smaller than the dimension (width dimension) of the arm body 51A in the left-right direction. The first housing 18 includes the reinforcement portions 78D located at positions that are outside the lock protrusion 51B in the left-right direction and overlap with the arm body 51A in the left-right direction, when the first housing 18 is fitted to the second housing 22. The reinforcement portions 78D protrude from the upper wall 78A to the respective ribs 78B so as to connect the upper wall 78A and the respective ribs 78B.

According to this configuration, the upper wall 78A is reinforced by the reinforcement portions 78D, and thus it is difficult for the upper wall 78A to bend even when a force is applied in the direction of separating the first housing 18 and the second housing 22 from each other with the lock protrusion 51B and the lock portion 78C engaged with each other. This can make it difficult for the engaged lock protrusion 51B and lock portion 78C to be disengaged.

The reinforcement portions 78D extend in the fitting direction and the front ends of the reinforcement portions 78D in the fitting direction are continuous with the lock portion 78C. As a result of the front ends of the reinforcement portions 78D being continuous with the lock portion 78C, it is possible to make the upper wall 78A more difficult to bend.

The rear ends of the reinforcement portions 78D in the fitting direction are located forward relative to the rear end of the upper wall 78A. By defining the length dimension of the reinforcement portions 78D in the fitting direction, the upper wall 78A, as the minimum necessary dimension, formability can be improved.

At the leading end of the lock protrusion 51B in the protruding direction, the top surface 51C is formed extending in the fitting direction while intersecting with the lock surface 51F facing the lock portion 78C. When the first housing 18 and the second housing 22 are in the fitted state, the top surface 51C is located at a position included within the formation range of the reinforcement portions 78D in the fitting direction. According to this configuration, since the reinforcement portions 78D are provided, on the upper wall 78A, corresponding to a range to be pressed by the lock protrusion 51B, the upper wall 78A can be effectively prevented from bending.

### Other Embodiments

The embodiments disclosed herein are examples in all respects, and should be construed as non-limiting. The scope of the present invention is not limited to the embodiments disclosed herein, but is indicated by the claims and intended to include all modifications within the meaning and scope equivalent to the claims.

In contrast to Embodiment 1, the outer shape of the reinforcement portions viewed from the rear may be such that their widths increase upward and toward the center in the left-right direction.

In Embodiment 1, the rear ends of the reinforcement portions are located forward relative to the rear end of the upper wall, but the rear ends of the reinforcement portions may be extended to the rear end of the upper wall.

The male terminal may be attached to the second housing and the female terminal may be attached to the first housing.

In contrast to Embodiment 1, a configuration is also possible in which the reinforcement portions and the ribs are provided on the left side wall, the right side wall, or the lower wall.

### LIST OF REFERENCE NUMERALS

10 . . . Connector
18 . . . First housing
22 . . . Second housing
47 . . . Second terminal receptacle
48 . . . Second lance
51 . . . Lock arm
51A . . . Arm body
51B . . . Lock protrusion
51C . . . Top surface
51D . . . Inclined surface
51E . . . Finger-pressing portion
51F . . . Lock surface
75 . . . First terminal receptacle
76 . . . First lance
78 . . . Tubular fitting portion
78A . . . Upper wall (covering wall)
78B . . . Rib
78C . . . Lock portion
78D . . . Reinforcement portion
78E . . . Left and right side walls (covering wall)
78F . . . Lower wall (covering wall)
F . . . Female terminal
L1, L2 . . . Engaged portion
M . . . Male terminal

1. A connector comprising:
a first housing and a second housing;
wherein the first housing includes a tubular fitting portion to which the second housing can be fitted,
the tubular fitting portion includes: a covering wall that externally covers the second housing; a pair of ribs that protrude inward from the covering wall and face each other in a width direction that intersects with a fitting direction of the first housing and second housing; and a lock portion that protrudes inward from the covering wall and is positioned between the ribs,
the second housing includes a lock arm that is positioned between the ribs when the second housing is fitted to the first housing,
the lock arm includes an arm body that is elastically deformable, and a lock protrusion that protrudes from the arm body and is configured to engage with the lock portion,
a dimension of the lock protrusion in the width direction is smaller than a dimension of the arm body in the width direction,
the first housing includes reinforcement portions located at positions that are outside the lock protrusion in the width direction and overlap with the arm body in the width direction when the first housing is fitted to the second housing, and
the reinforcement portions protrude from the covering wall to the ribs.

2. The connector according to claim 1,
wherein the reinforcement portions extend in the fitting direction, and
front ends of the reinforcement portions in the fitting direction are continuous with the lock portion.

3. The connector according to claim 2,
wherein rear ends of the reinforcement portions in the fitting direction are located forward relative to a rear end of the covering wall.

4. The connector according to claim 2,
wherein a top surface is formed at a leading end of the lock protrusion in a protruding direction, the top surface extending in the fitting direction while intersecting with a lock surface that faces the lock portion, and
when the first housing and the second housing are in a fitted state, the top surface is located at a position included within a formation range of the reinforcement portions in the fitting direction.
